(19) United States
(12) Patent Application Publication
(10) Pub. No.: US 2023/0092224 A1
(43) Pub. Date: Mar. 23, 2023

(54) Cooperative Sensing for Sidelink Communication

(71) Applicant: Fraunhofer-Gesellschaft zur Foerderung der angewandten Forschung e.V., Munich (DE)

(72) Inventors: Dariush MOHAMMAD SOLEYMANI, Erlangen (DE); Martin LEYH, Erlangen (DE); Bernhard NIEMANN, Erlangen (DE); Elke ROTH-MANDUTZ, Erlangen (DE); Shubhangi BHADAURIA, Erlangen (DE); Mehdi HAROUNABADI, Erlangen (DE); Dietmar LIPKA, Erlangen (DE)

(21) Appl. No.: 17/991,481

(22) Filed: Nov. 21, 2022

Related U.S. Application Data
(63) Continuation of application No. PCT/EP2021/063708, filed on May 21, 2021.

(30) Foreign Application Priority Data
May 22, 2020 (EP) 20176138.4
Oct. 22, 2020 (EP) 20203435.1

(51) Int. Cl. H04W 72/02; H04W 72/04; H04W 72/10

(52) U.S. Cl. CPC H04W 72/02; H04W 72/0406; H04W 72/10

(57) ABSTRACT

Embodiments provide a method for sharing sensing information between at least two transceivers of a wireless communication system, the at least two transceivers operating in a sidelink in-coverage, out of coverage or partial coverage scenario, in which resources for a sidelink communication over a sidelink are pre-configured by the wireless communication system or allocated or scheduled autonomously by the at least two transceivers, the method including: performing, with the first transceiver, a continuous or partial sensing of a first set of resources of the sidelink, in order to obtain a first sensing information, the first sensing information describing an occupancy of at least a proper subset of the first set of resources of the sidelink; performing a first sidelink transmission from the first transceiver to a second transceiver of the at least two transceivers, wherein the first sidelink transmission includes the first sensing information.

### CROSS-REFERENCES TO RELATED APPLICATIONS

This application is a continuation of copending International Application No. PCT/EP2021/063708, filed May 21, 2021, which is incorporated herein by reference in its entirety, and additionally claims priority from European Applications Nos. EP 20 176 138.4, filed May 22, 2020, and EP 20 203 435.1, filed Oct. 22, 2020, all of which are incorporated herein by reference in their entirety.

### BACKGROUND OF THE INVENTION

Embodiments of the present application relate to the field of wireless communication, and more specifically, to wireless communication between a plurality of user equipments via the sidelink, SL. Some embodiments relate to a cooperative sensing for sidelink communication.

FIG. 1 is a schematic representation of an example of a terrestrial wireless network 100 including, as is shown in FIG. 1((a), a core network 102 and one or more radio access networks RAN1, RAN2, . . . RANN. FIG. 1(b) is a schematic representation of an example of a radio access network RANn that may include one or more base stations gNB1 to gNB5, each serving a specific area surrounding the base station schematically represented by respective cells 1061 to 1065. The base stations are provided to serve users within a cell. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANn may include more or less such cells, and RANn may also include only one base station. FIG. 1(b) shows two users UE1 and UE2, also referred to as user equipment, UE, that are in cell 1062 and that are served by base station gNB2. Another user UE3 is shown in cell 1064 which is served by base station gNB4. The arrows 1081, 1082 and 1083 schematically represent uplink/downlink connections for transmitting data from a user UE1, UE2 and UE3 to the base stations gNB2, gNB4 or for transmitting data from the base stations gNB2, gNB4 to the users UE1, UE2, UE3. Further, FIG. 1(b) shows two IoT devices 1101 and 1102 in cell 1064, which may be stationary or mobile devices. The IoT device 1101 accesses the wireless communication system via the base station gNB4 to receive and transmit data as schematically represented by arrow 1121. The IoT device 1102 accesses the wireless communication system via the user UE3 as is schematically represented by arrow 1122. The respective base station gNB1 to gNB5 may be connected to the core network 102, e.g., via the S1 interface, via respective backhaul links 1141 to 1145, which are schematically represented in FIG. 1(b) by the arrows pointing to “core”. The core network 102 may be connected to one or more external networks. Further, some or all of the respective base station gNB1 to gNB5 may connected, e.g., via the S1 or X2 interface or the XN interface in NR, with each other via respective backhaul links 1161 to 1165, which are schematically represented in FIG. 1(b) by the arrows pointing to “gNBs”.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB), the physical downlink shared channel (PDSCH) carrying for example a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels, or more precisely the transport channels according to 3GPP, may further include the physical random access channel (PRACH or RACH) used by UEs for accessing the network once a UE is synchronized and has obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix (CP) length. All OFDM symbols may be used for DL or UL or only a subset, e.g., when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g., DFT-s-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard.

The wireless network or communication system depicted in FIG. 1 may by a heterogeneous network having distinct overlaid networks, e.g., a network of macro cells with each macro cell including a macro base station, like base station gNB1 to gNB5, and a network of small cell base stations (not shown in FIG. 1), like femto or pico base stations.

In addition to the above described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the NR (5G), new radio, standard.

In mobile communication networks, for example in a network like that described above with reference to FIG. 1, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5 interface, one of the UEs may also be connected with a BS, and may relay information from the BS to the other UE via the sidelink interface. The relaying may be performed in the same frequency band (in-band-relay) or another frequency band (out-of-band relay) may be used. In the first case, communication on the Uu and on the sidelink may be decoupled using different time slots as in time division duplex, TDD, systems.

FIG. 2 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 3 is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 3 which is the out-of-coverage scenario does not necessarily mean that the respective mode 2 UEs (in NR) or mode 4 UEs (in LTE) are outside of the coverage 200 of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area 200 shown in FIG. 2, in addition to the NR mode 1 or LTE mode 3 UEs 202, 204 also NR mode 2 or LTE mode 4 UEs 206, 208, 210 are present.

Naturally, it is also possible that the first vehicle 202 is covered by the gNB, i.e. connected with Uu to the gNB, wherein the second vehicle 204 is not covered by the gNB and only connected via the PC5 interface to the first vehicle 202, or that the second vehicle is connected via the PC5 interface to the first vehicle 202 but via Uu to another gNB, as will become clear from the discussion of FIGS. 4 and 5.

FIG. 4 is a schematic representation of a scenario in which two UEs directly communicating with each, wherein only one of the two UEs is connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204, wherein only the first vehicle 202 is in the coverage area 200 of the base station gNB. Both vehicles 202, 204 are connected directly with each other over the PC5 interface.

FIG. 5 is a schematic representation of a scenario in which two UEs directly communicating with each, wherein the two UEs are connected to different base stations. The first base station gNB1 has a coverage area that is schematically represented by the first circle 2001, wherein the second station gNB2 has a coverage area that is schematically represented by the second circle 2002. The UEs directly communicating with each other include a first vehicle 202 and a second vehicle 204, wherein the first vehicle 202 is in the coverage area 2001 of the first base station gNB1 and connected to the first base station gNB1 via the Uu interface, wherein the second vehicle 204 is in the coverage area 2002 of the second base station gNB2 and connected to the second base station gNB2 via the Uu interface.

In a wireless communication system as described above, power saving is crucial for battery-driven UEs.

3GPP Rel.17 [1] has called for investigations and proposals on energy saving for Pedestrian UE (P-UE) in its Work Item (WI) on New Radio (NR) sidelink enhancements. P-UEs usually depend on the lifetime of their batteries, which have a limited capacity. P-UEs which operate on mode 1 or 2 of 5G NR sidelink radio resource allocation need to apply mechanisms to reduce energy consumption and prolong their lifetime. One of the major reasons for depletion of the battery in P-UEs is the continuous sensing which takes place for radio resource selection in the physical layer of such devices. Moreover, the sensing is not always perfect to provide a global view from the radio spectrum.

3GPP [2] has defined two modes of radio resource allocation for sidelink communication in V2X (Vehicle to everything) scenarios, i.e., mode 3 and 4 in LTE and mode 1 and 2 in 5G NR. In mode 4 of LTE and mode 2 of 5G NR, a UE allocates radio resources autonomously without the assistance of eNodeB or gNodeB in in-coverage, partial-coverage, and out-of-coverage cases. A UE can select radio resources applying one of the following mechanisms:
1. Random radio resource selection
2. (Partial) Sensing based radio resource selection

The mechanism to apply for autonomous radio resource selection in the physical layer of a UE is configured by the higher layers using Information Elements (IEs), which are exchanged between layers of the protocol stack.

In all above mentioned mechanisms, in subframe n, a UE shall report a set of resources for transmission of the Physical Sidelink Shared CHannel (PSSCH) and Physical Sidelink Control Channel (PSCCH) to the higher layers.

Candidate Subframe Resources

A candidate single-slot resource, Rxy, for PSSCH is defined according to 3GPP TS 36.213/TS 38.214 as a set of L contiguous sub-channels with sub-channel x+j in single-slot ty where j=0,1, . . . , L−1 and x is the sub-channel starting at the lowest frequency of the resource within the resource pool. The UE shall assume any set of L contiguous sub-channels included in the PSSCH resource pool within the time interval [n+T1, n+T2], where n is the reference subframe for the sensing and resource selection window, with respect to a candidate subframe, T1 and T2 are processing time and packet delay budget. Moreover, the selection of T1 and T2 is up to UE implementations following below conditions:
In LTE
   T1⇐4
   T2 min(priorTX)⇐T2<100 and when the value of T2 is not configured by the higher layers, it is considered as 4⇐T2<100
In 5G NR
   T1 is up to UE implementation under 0⇐T1⇐Tproc,1 where Tproc,1 [e.g. Tproc1 is processing time]
   If T2 is shorter than the Remaining packet Delay Budget (RDB) then T2 is up to UE implementations under T2 min⇐T2⇐RDB. Otherwise, T2 is set to RDB

The total number of the candidate subframes is set by parameter Mtotal.

Random Radio Resource Selection

In case where the IE from higher layers configures the random radio resource selection in a UE, the set of resources to report to the higher layers for PSSCH transmission is defined as follows:
The set Sa is defined based on all above-mentioned candidate single-slot resources defined for the resource pool of PSSCH by the higher layers.
The UE excludes candidate resources from Sa which the UE does not support transmission in the candidate single-slot resource in the carrier with the assumption that transmissions take place in other carrier(s) using the already selected resources. This is due to the limitation of the UE in the number of simultaneous transmission carriers and the limitation of the UE to support carrier combinations, or the interruption of RF retuning time.
The UE reports Sa to the higher layers.

Sensing Based Radio Resource Selection

If sensing or partial sensing-based radio resource selection is configured by the higher layers, the UE shall monitor the radio spectrum to find the occupancy of radio resources and exclude radio resource subframes with a high measured energy level to avoid the collision.

In 5G NR, if the sensing-based radio resource selection is configured by the higher layers, the UE does the following steps:
The UE does a continuous sensing on the candidate single-slot resources within the sensing window [e.g., by the range of slots [n−T0, n−Tproc,0] where T0 is a sensing window raning between [1000+100, 100] ms/slots and Tproc,0]. The UE shall monitor slots which can belong to the sidelink resource pool within the sensing window except for those in which it transmits itself.
The UE initializes the set Sa with all candidate single-slot resources.
The UE excludes single-slot resources from the Sa if one of the following conditions are met:
   UE receieves SCI in the slot wherein the measured RSRP is higher than the threshold, which is defined by the higher layers, with respect to the priority field in the received SCI and the priority of the transmission, which is defined by the higher layers.
   The slot is reserved by other UEs through a SCI in its “resource reservation period” field and the reservation of resources is allowed by the higher layers through “reservationPeriodAllowed” IE.
   The slot could not be sensed by the UE for any reason.
If the number of remaining candidate resources in set Sa is less than 20% of Mtotal, then the UE increases RSRP threshold, i.e., Th(pi), by 3 dB for each priority level and re-initiate the resource selection procedure as mentioned above.

The radio resource selection for P-UEs is limited to random radio resource selection and partial sensing-based radio resource selection. The type of resource selection for P-UEs is configured by SL-P2X-ResourceSelectionConfigIE [6].

The below example indicates the SL-P2X-ResourceSelectionConfig information element, IE:

-- ASN1START

| SL-P2X-ResourceSelectionConfig-r14 ::= | SEQUENCE { | | |
|---|---|---|---|
| partialSensing-r14 | ENUMERATED {true} | OPTIONAL, | -- Need OR |
| randomSelection-r14 | ENUMERATED {true} | OPTIONAL | -- Need OR |

}
-- ASN1STOP

In a P-UE configured to the partial sensing, the same steps for the resource selection take place but the physical layer avoids continuous sensing. Instead of the continuous sensing, the P-UE does sensing within the sensing window as follows:
At defined time instances
At limited and defined durations
With configured Pstep

Partial Sensing based on EP 20166532 A1

All the parameters of partial sensing, as mentioned above, can be configured based on the following conditions and state parameters:
Traffic type, e.g., aperiodic/periodic traffic
Cast type (broadcast, groupcast (multicast), unicast)
Network coverage (in/partial/out)
UE position—e.g. geo-position, area the UE is located, relative position to other UEs
   Geographical position of the UE, e.g. in the vicinity of roads or junction/intersection
   Area(s) the UE is located, e.g. zone or validity area
   distance between UEs, UE density
Minimum communication range: parameter included in SCI
UE battery charge level, e.g. a threshold based on the battery charge level (e.g. low battery, such as 20% battery charge level) based on which the partial sensing parameters are adapted to further reduce the energy consumption
QoS parameters i.e. at least priority, reliability

Finally, by collection of information, i.e., measurement results of partial sensing, the UE defines set Sa as mentioned earlier and by exclusion of some single-slot resources based on their occupancy rate and the other above-mentioned conditions for sensing based resource selection, it reports Sa to the higher layers.

Sidelink Control Information

When Sa is reported to the higher layer applying any type of resource selection mechanisms, the higher layer (i.e. MAC layer) chooses single-slot resources randomly with a uniform distribution to avoid collision on certain resources. In LTE, after selection of resources, the UE sends Sidelink Control Information (SCI) in the Physical Sidelink Control Channel (PSCCH) which uses the first two Physical Resource Blocks (PRBs) of the first sub-channel if the adjacent PSCCH and PSSCH is configured by higher layers. The SCI informs other UEs in the proximity about the selected resources and help them to decode data messages.

In 5G NR [8], a two stage SCI is introduced in which the 1^{st} stage is used for scheduling of PSSCH and scheduling of 2^{nd} stage SCI on PSSCH. The 1^{st} stage SCI format 0-1 contains the following fields:
Priority—3 bits
Frequency resource assignment—n bits. n depends on the configuration of higher layers and the number of sub-channels in the resource pool
Time resource assignment—5, 9 bits depending on the configuration of higher layers
Resource reservation period—n or 0 bit depending on the configurations of higher layers
DMRS pattern—x bit if more than one pattern is configured by higher layers, otherwise 0 bit
2nd-stage SCI forma—n bits
Beta_offset indicator—[2] bits as provided by higher layer parameter sl-BetaOffsets2ndSCI
Number of DMRS port—1 bit
Modulation and coding scheme—5 bits
Reserved—[2-4] bits

In the 2^{nd} stage SCI (format 0-2) the following information is transmitted:
HARQ Process ID—n bits
New data indicator—1 bit
Redundancy version—2 bits
Source ID—8 bits
Destination ID—16 bits
CSI request —1 bit

If the 2^{nd} stage SCI format field in the 1^{st} stage SCI indicates a groupcast, the following information is also transmitted in the 2^{nd} stage SCI
Zone ID—12 bits
Communication range requirements—4 bits

ProSe (Proximity Service) Discovery Procedure

For cooperation of UEs in sensing procedure, UEs may have to discover other UEs in their proximity. In 3GPP release 12 [5], following models for ProSe (Proximity Services) Direct Discovery exist.

Model A (“I am here”)

This model defines two roles for the ProSe-enabled UEs that are participating in ProSe Direct Discovery:
Announcing UE: The UE announces certain information that could be used by UEs in proximity that have permission to discover.
Monitoring UE: The UE that monitors certain information of interest in proximity of announcing UEs.

In this model the announcing UE broadcasts discovery messages at pre-defined discovery intervals and the monitoring UEs that are interested in these messages read them and process them.

This model is equivalent to “I am here” since the announcing UE would broadcast information about itself e.g. its ProSe Application Identities or ProSe UE Identities in the discovery message.

Model B (“Who is There?”/“Are You There?”)

This model defines two roles for the ProSe-enabled UEs that are participating in ProSe Direct Discovery:
Discoverer UE: The UE transmits a request containing certain information about what it is interested to discover.
Discoveree UE: The UE that receives the request message can respond with some information related to the discoverer's request.

This model is same as “who is there/are you there” since the discoverer UE sends information about other UEs that would like to receive responses from, e.g. the information can be about a ProSe Application Identity corresponding to a group and the members of the group can respond.

In view of the above there is the need to save energy in UEs and enhance the resource selection in P-UEs and Vehicular UEs (V-UEs).

It is noted that the information in the above section is only for enhancing the understanding of the background of the invention and therefore it may contain information that does not form conventional technology and is not already known to a person of ordinary skill in the art.

### SUMMARY

An embodiment may have a method for sharing sensing information between at least two transceivers of a wireless communication system, the at least two transceivers operating in a sidelink in-coverage, out of coverage or partial coverage scenario, in which resources for a sidelink communication over a sidelink are pre-configured by the wireless communication system or allocated or scheduled autonomously by the at least two transceivers, the method comprising: performing, with the first transceiver, a continuous or partial sensing of a first set of resources of the sidelink, in order to acquire a first sensing information, the first sensing information describing an occupancy of at least a proper subset of the first set of resources of the sidelink, performing a first sidelink transmission from the first transceiver to a second transceiver of the at least two transceivers, wherein the first sidelink transmission comprises the first sensing information; wherein the first sidelink transmission is a transmission of a second stage sidelink control information.

Another embodiment may have a method for sharing sensing information between at least two transceivers of a wireless communication system, the at least two transceivers operating in a sidelink in-coverage, out of coverage or partial coverage scenario, in which resources for a sidelink communication over a sidelink are pre-configured by the wireless communication system or allocated or scheduled autonomously by the at least two transceivers, the method comprising: performing, with the first transceiver, a continuous or partial sensing of a first set of resources of the sidelink, in order to acquire a first sensing information, the first sensing information describing an occupancy of at least a proper subset of the first set of resources of the sidelink, performing a first sidelink transmission from the first transceiver to a second transceiver of the at least two transceivers, wherein the first sidelink transmission comprises the first sensing information; wherein the transmission of the first sidelink transmission and/or a periodicity of the transmission of the first sidelink transmission depends on at least one out of a reception of cooperation request requesting a sharing of the sensing information, a quality of service or quality requirement of the first transceiver and/or the second transceiver, and/or of a priority of traffic of the second transceiver, a social's or operator's credit.

Another embodiment may have a first transceiver of a wireless communication system, the first transceiver operating in a sidelink in-coverage, out of coverage or partial coverage scenario, in which resources for a sidelink communication over a sidelink are pre-configured by the wireless communication system or allocated or scheduled autonomously by the first transceiver, the method comprising: performing a continuous or partial sensing of a first set of resources of the sidelink, in order to acquire a first sensing information, the first sensing information describing an occupancy of at least a proper subset of the first set of resources of the sidelink, performing a first sidelink transmission from the first transceiver to a second transceiver of the wireless communication network, wherein the first sidelink transmission comprises the first sensing information; wherein the first sidelink transmission is a transmission of a second stage sidelink control information.

Another embodiment may have a second transceiver of a wireless communication system, the second transceiver operating in a sidelink in-coverage, out of coverage or partial coverage scenario, in which resources for a sidelink communication over a sidelink are pre-configured by the wireless communication system or allocated or scheduled autonomously by the second transceiver, the method comprising: receiving a first sidelink transmission from a first transceiver of the wireless communication network, wherein the first sidelink transmission comprises a first sensing information acquired by the first transceiver by performing a continuous or partial sensing of a first set of resources of the sidelink, the first sensing information describing an occupancy of at least a proper subset of the first set of resources of the sidelink; wherein the first sidelink transmission is a transmission of a second stage sidelink control information.

Another embodiment may have a method for operating a first transceiver of a wireless communication system, the method comprising: operating the first transceiver in a sidelink in-coverage, out of coverage or partial coverage scenario, in which resources for a sidelink communication over a sidelink are pre-configured by the wireless communication system or allocated or scheduled autonomously by the first transceiver, performing a continuous or partial sensing of a first set of resources of the sidelink, in order to acquire a first sensing information, the first sensing information describing an occupancy of at least a proper subset of the first set of resources of the sidelink, performing a first sidelink transmission from the first transceiver to a second transceiver of the wireless communication network, wherein the first sidelink transmission comprises the first sensing information, wherein the first sidelink transmission is a transmission of a second stage sidelink control information.

Another embodiment may have a method for operating a second transceiver of a wireless communication system, the method comprising: operating the second transceiver in a sidelink in-coverage, out of coverage or partial coverage scenario, in which resources for a sidelink communication over a sidelink are pre-configured by the wireless communication system or allocated or scheduled autonomously by the second transceiver, receiving a first sidelink transmission from a first transceiver of the wireless communication network, wherein the first sidelink transmission comprises a first sensing information acquired by the first transceiver by performing a continuous or partial sensing of a first set of resources of the sidelink, the first sensing information describing an occupancy of at least a proper subset of the first set of resources of the sidelink; wherein the first sidelink transmission is a transmission of a second stage sidelink control information.

Another embodiment may have a non-transitory digital storage medium having a computer program stored thereon to perform the method for operating a first transceiver of a wireless communication system, the method comprising: operating the first transceiver in a sidelink in-coverage, out of coverage or partial coverage scenario, in which resources for a sidelink communication over a sidelink are pre-configured by the wireless communication system or allocated or scheduled autonomously by the first transceiver, performing a continuous or partial sensing of a first set of resources of the sidelink, in order to acquire a first sensing information, the first sensing information describing an occupancy of at least a proper subset of the first set of resources of the sidelink, performing a first sidelink transmission from the first transceiver to a second transceiver of the wireless communication network, wherein the first sidelink transmission comprises the first sensing information, wherein the first sidelink transmission is a transmission of a second stage sidelink control information, when said computer program is run by a computer.

Another embodiment may have a non-transitory digital storage medium having a computer program stored thereon to perform the method for operating a second transceiver of a wireless communication system, the method comprising: operating the second transceiver in a sidelink in-coverage, out of coverage or partial coverage scenario, in which resources for a sidelink communication over a sidelink are pre-configured by the wireless communication system or allocated or scheduled autonomously by the second transceiver, receiving a first sidelink transmission from a first transceiver of the wireless communication network, wherein the first sidelink transmission comprises a first sensing information acquired by the first transceiver by performing a continuous or partial sensing of a first set of resources of the sidelink, the first sensing information describing an occupancy of at least a proper subset of the first set of resources of the sidelink; wherein the first sidelink transmission is a transmission of a second stage sidelink control information, when said computer program is run by a computer.

### BRIEF DESCRIPTION OF THE DRAWINGS

Embodiments of the present invention will be detailed subsequently referring to the appended drawings, in which:

FIG. 1a-b shows a schematic representation of an example of a wireless communication system;

FIG. 2 is a schematic representation of an in-coverage scenario in which UEs directly communicating with each other are connected to a base station;

FIG. 3 is a schematic representation of an out-of-coverage scenario in which UEs directly communicating with each other receive no SL resource allocation configuration or assistance from a base station;

FIG. 4 is a schematic representation of a partial out-of-coverage scenario in which some of the UEs directly communicating with each other receive no SL resource allocation configuration or assistance from a base station;

FIG. 5 is a schematic representation of an in-coverage scenario in which UEs directly communicating with each other are connected to different base stations;

FIG. 6 is a schematic representation of a wireless communication system comprising a transceiver, like a base station or a relay, and a plurality of communication devices, like UEs;

FIG. 7 shows a schematic representation of a wireless communication system comprising a first transceiver, like a UE, and a second transceiver, like a UE, wherein the first transceiver shares its sensing results with the second transceiver,

FIG. 8 shows a schematic representation of a wireless communication system comprising a first transceiver, like a UE, and a second transceiver, like a UE, wherein the first transceiver shares its sensing results with the second transceiver in response to a sensing information sharing request of the second transceiver,

FIG. 9 shows a schematic representation of a wireless communication system comprising a first transceiver, like a UE, a second transceiver, like a road side unit, and a third transceiver, like a UE, wherein the first transceiver shares its sensing results with the third transceiver in response to a sensing information sharing request of the second transceiver,

FIG. 10 illustrates an example of a computer system on which units or modules as well as the steps of the methods described in accordance with the inventive approach may execute.

### DETAILED DESCRIPTION OF THE INVENTION

Equal or equivalent elements or elements with equal or equivalent functionality are denoted in the following description by equal or equivalent reference numerals.

In the following description, a plurality of details are set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

As indicated in the introductory part of the present patent application, the partial sensing is configured by higher layers to limit the number of sensing time instances and duration and consequently save energy in P-UEs. However, due to the limited measurements applying partial sensing, the selected resources may be unable to fulfill the reliability requirements of an application. The reason for lower reliability applying partial sensing is a higher probability of collisions in the selected resources due to the missing/few sensing instances on the selected resources. To provide the required reliability and latency requirements, a P-UE shall increase the number of time instances and sensing duration to have a better view from available resources. This leads to more power consumption in a P-UE.

Embodiments described herein allow to save energy in UEs and enhance the resource selection in P-UEs and Vehicular UEs (V-UEs) by providing more information for them.

In accordance with embodiments, the cooperation of UEs is proposed in the form of exchanging sensing measurement results or suggestions about unoccupied resources to increase reliability and to reduce the latency of transmissions in sidelink communication by keeping the amount of energy consumption low. By cooperation of UEs, the following benefits can be achieved:
The reliability of sidelink communication having more information for resource selection can be increased
UEs can reduce data transmission time by selecting more reliable resources and avoiding retransmissions in some cast types such as unicast/groupcast transmissions
Problems such as hidden terminal and exposed terminal are resolved
P-UEs with very low battery level may stop the sensing or minimize the number sensing time instances, in the case of partial sensing, after the reception of the sensing information from other UEs, i.e., cooperative information
Cooperative sensing can address the half-duplex problem during UE transmission and re-transmission (for e.g. a UE may cooperate (e.g. sending the sensing results) with other UEs which transmit simultaneously on sidelink to assist them to avoid collision since transmitting UEs may not recognize any collision while transmitting i.e. half duplex problem).

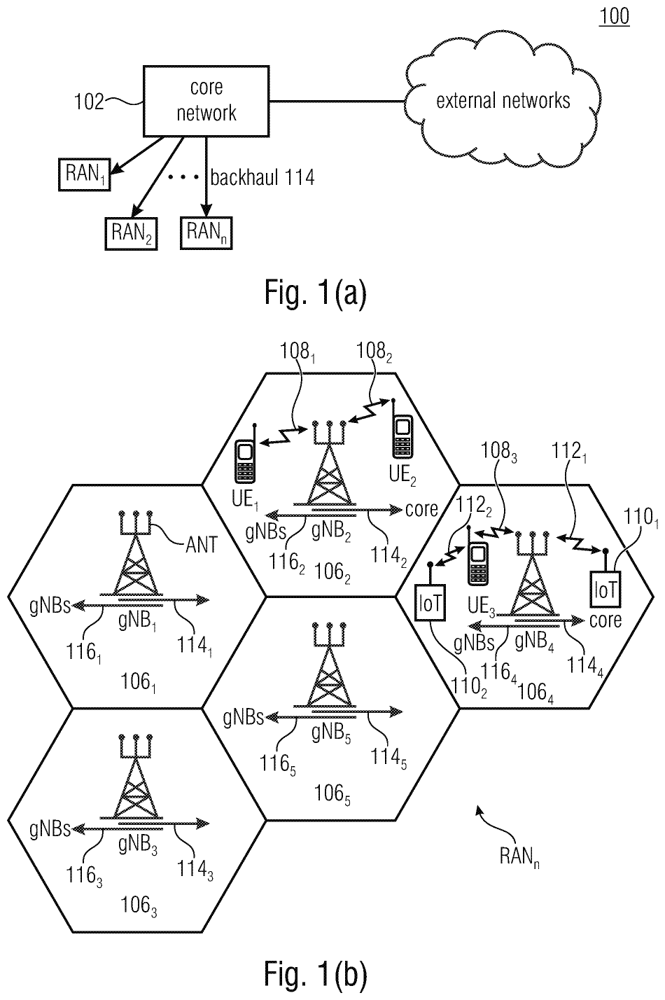

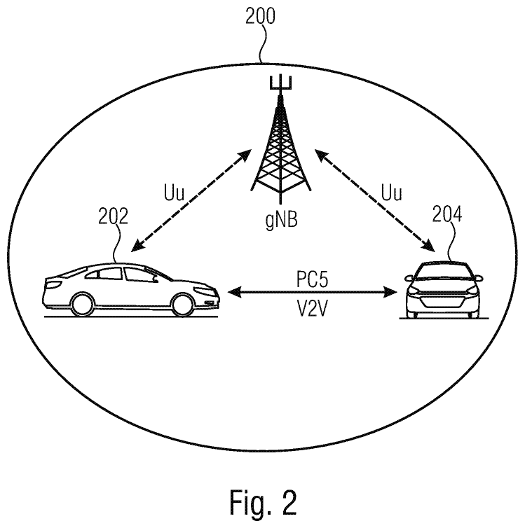

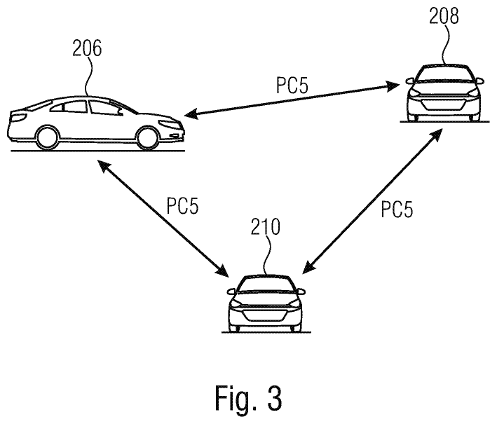

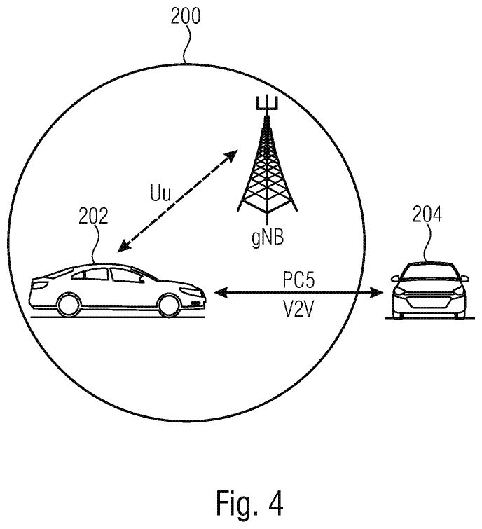

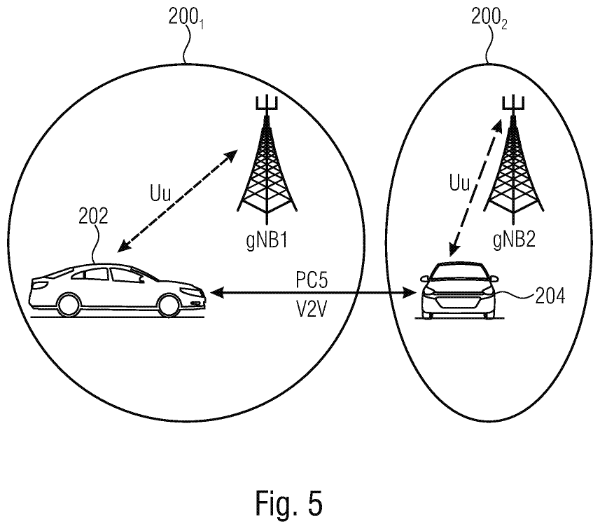

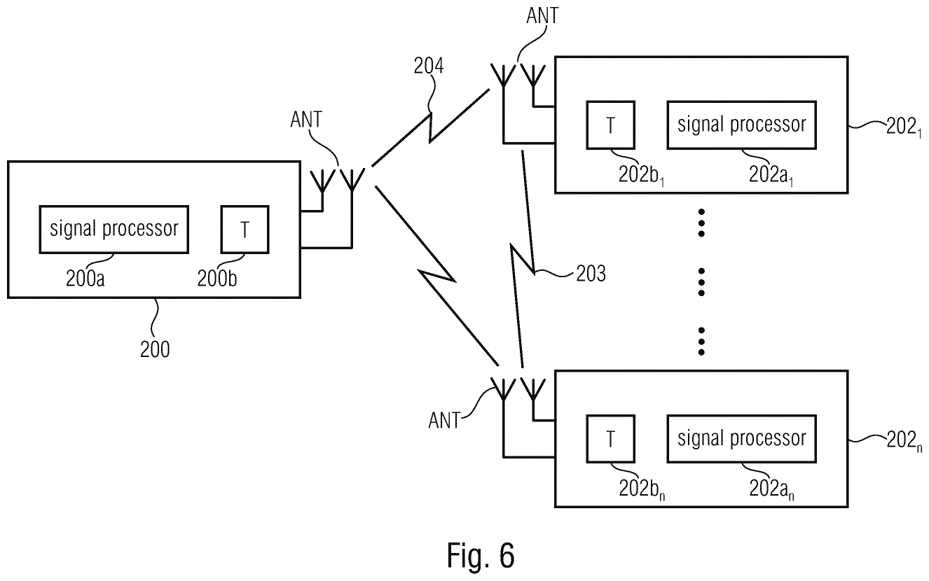

Embodiments of the present invention may be implemented in a wireless communication system or network as depicted in FIGS. 1 to 5 including a transceiver, like a base station, gNB, or relay, and a plurality of communication devices, like user equipment's, UEs. FIG. 6 is a schematic representation of a wireless communication system comprising a transceiver 200, like a base station or a relay, and a plurality of communication devices 202₁ to 202ₙ, like UEs. The UEs might communicated directly with each other via a wireless communication link or channel 203, like a radio link (e.g., using the PC5 interface (sidelink)). Further, the transceiver and the UEs 202 might communicate via a wireless communication link or channel 204, like a radio link (e.g., using the uU interface). The transceiver 200 might include one or more antennas ANT or an antenna array having a plurality of antenna elements, a signal processor 200a and a transceiver unit 200b. The UEs 202 might include one or more antennas ANT or an antenna array having a plurality of antennas, a signal processor 202a₁ to 202aₙ, and a transceiver unit 202b₁ to 202bₙ. The base station 200 and/or the one or more UEs 202 may operate in accordance with the inventive teachings described herein.

Embodiments provide a method for sharing sensing information between at least two transceivers 202₁ and 202₂ [e.g., V-UE 1 and P-UE 1] of a wireless communication system, the at least two transceivers 202₁ and 202₂ operating in a sidelink in-coverage, out of coverage or partial coverage scenario [e.g., NR sidelink mode [e.g., mode 1 or mode 2]], in which resources for a sidelink communication [e.g., transmission and/or reception] over a sidelink are pre-configured by the wireless communication system or allocated or scheduled autonomously by the at least two transceivers, the method comprising: performing, with the first transceiver 202₁ [e.g., V-UE ], a continuous or partial sensing of a first set of resources [e.g., sub-channels, a resource pool or a bandwidth part] of the sidelink, in order to obtain a first sensing information, the first sensing information describing an occupancy [e.g., based on energy level [e.g., RSRP or RSSI]] of at least a proper subset [e.g., Sa] of the first set of resources of the sidelink; performing a first sidelink transmission from the first transceiver 202₁ [e.g., V-UE 1] to a second transceiver 202₂ [e.g., P-UE 1] of the at least two transceivers 202₁ and 202₂, wherein the first sidelink transmission comprises the first sensing information.

In embodiments, the first sidelink transmission is one out of
a transmission of a first stage sidelink control information, SCI, [e.g., comprising the first sensing information (e.g. a set of sensing results or a set of resources) in a field of the first stage sidelink control information, SCI, [e.g., SCI format 0-1 indicating a set of contiguous unoccupied resources in time and frequency, or a bitmap]],
a transmission of a second stage sidelink control information, SCI, [e.g., comprising the first sensing information (e.g. a set of sensing results or a set of resources) in a field of the second stage control information [e.g., wherein a first stage sidelink control information, SCI, preceding the second stage sidelink control information, SCI, comprises an indication [e.g., indicator bit] [e.g., indicating the transmission of the first sensing information in the second stage sidelink control information, SCI]]],
a transmission of an information element, IE [e.g., MeasurementReportSidelink information element],
a transmission of a hybrid automatic repeat request, HARQ, feedback transmission,
a transmission of a broadcasting message [e.g., LTE mode 3 measurement report information element].

In embodiments, the transmission of the first sidelink transmission and/or a periodicity of the transmission of the first sidelink transmission depends on at least one out of
a type of the first transceiver and/or the second transceiver [e.g. P-UE or V-UE],
a battery level of the first transceiver and/or the second transceiver,
a velocity of the first transceiver and/or the second transceiver,
a reception of cooperation request requesting a sharing of the sensing information,
a quality of service or quality requirement of the first transceiver and/or the second transceiver, and/or of a priority of traffic of the second transceiver,
a social's or operator's credit [e.g., for sharing the sensing information],
a geo-location of the first transceiver and/or the second transceiver.

In embodiments, the first sidelink transmission or another sidelink transmission [e.g., a sidelink transmission of the second transceiver [e.g., P-UE 1] is performed using selected resources selected out of the first set of resources
based on the first sensing information or an information derived therefrom,
or only based on the first sensing information.

In embodiments, the first sidelink transmission or another sidelink transmission [e.g., a sidelink transmission of the second transceiver [e.g., P-UE 1] is performed using selected resources only selected out of the first set of resources.

In embodiments, the first sidelink transmission is, for example, a multicast transmission to a proper subset of transceivers of the wireless communication system, the proper subset of transceivers including the second transceiver, wherein transceivers of the proper subset of transceivers fulfill at least one out of the following conditions:
the respective transceiver is located in proximity of the first transceiver or within a defined distance to the first transceiver [e.g., within the same zone or within a group of ,e.g., adjacent zones, within the same or an adjacent/nearby validity area, within the same cell or within a group of cells [e.g., neighbor cells, cells in proximity]],
the respective transceiver is located within a given relative distance to the first transceiver,
the respective transceiver is member of the same group of transceivers as the first transceiver.

In embodiments, the method further comprises: performing, with the second transceiver or another transceiver of the wireless communication system, a sidelink transmission to the first transceiver [e.g., the first transceiver is the intended receiver], wherein the sidelink transmission is performed using selected resources selected out of the first set of resources
based on the first sensing information or an information derived therefrom,
or only based on the first sensing information.

In embodiments, the sidelink transmission is performed using selected resources only selected out of the first set of resources.

In embodiments, the method further comprises performing a second sidelink transmission from the second transceiver [e.g., P-UE 1] to a third transceiver [e.g., P-UE 2] of the at least two transceivers, wherein the second sidelink transmission comprises the first sensing information or an information derived therefrom.

In embodiments, the first sensing information is relayed by means of the second sidelink transmission to the third transceiver.

In embodiments, the second sidelink transmission is one out of
a transmission of a first stage sidelink control information, SCI, [e.g., comprising the first sensing information or the information derived therefrom in a field of the first stage sidelink control information, SCI, [e.g., SCI format 0-1 indicating a set of contiguous unoccupied resources in time and frequency, or a bitmap]],
a transmission of a second stage sidelink control information [e.g., comprising the first sensing information or the information derived therefrom in a field of the second stage control information, SCI, [e.g., wherein a first stage sidelink control information, SCI, preceding the second stage sidelink control information, SCI, comprises an indication [e.g., indicator bit] [e.g., indicating the transmission of the first sensing information or the information derived therefrom in the second stage sidelink control information, SCI]]],
a transmission of an information element, IE [e.g., MeasurementReportSidelink information element],
a transmission of a hybrid automatic repeat request, HARQ, feedback,
a transmission of a broadcasting message [e.g., LTE mode 3 measurement report information element].

In embodiments, the transmission of the second sidelink transmission and/or a periodicity of the transmission of the second sidelink transmission depends on at least one out of
a type of the second transceiver and/or the third transceiver [e.g. V-UE or P-UE],
a battery level of the second transceiver and/or the third transceiver,
a velocity of the second transceiver and/or the third transceiver,
a reception of cooperation request requesting a sharing of the sensing information,
a quality of service or quality requirement of the second transceiver and/or the third transceiver, and/or of a priority of traffic of the third transceiver,
a social's or operator's credit [e.g., for sharing/relaying sensing information],
a geo-location of second transceiver and/or the third transceiver.

In embodiments, the second sidelink transmission or another sidelink transmission [e.g., a sidelink transmission of the third transceiver [e.g., P-UE 2]] is performed using selected resources selected out of the first or second set of resources based on the first or second sensing information or the information derived therefrom.

In embodiments, the method further comprises performing, with the second transceiver, a continuous or partial sensing of a second set of resources of the sidelink, in order to obtain a second sensing information, the second sensing information describing an occupancy [e.g., energy level [e.g., RSRP or RSSI]] of at least a proper subset of the second set of resources of the sidelink; performing a second sidelink transmission from the second transceiver to the first transceiver or a third transceiver of the at least two transceivers, wherein the second sidelink transmission comprises one out of
the first sensing information and the second sensing information,
an updated sensing information obtained by updating the first sensing information based on the second sensing information,
a combined sensing information derived from a combination of the first sensing information and the second sensing information,

wherein the first set of resources and the second set of resources are the same sets of resources, different sets of resources or partially overlapping sets of resources.

In embodiments, the second sidelink transmission is one out of
a transmission of a first stage sidelink control information, SCI, [e.g., comprising the one out of the first sensing information and the second sensing information, the updated sensing information, and the combined sensing information in a field of the first stage sidelink control information, SCI [e.g., format 0-1 indicating a set of contiguous unoccupied resources in time and frequency, or a bitmap]],
a transmission of a second stage sidelink control information [e.g., comprising the one out of the first sensing information and the second sensing information, the updated sensing information, and the combined sensing information in a field of the second stage control information [e.g., wherein a first stage sidelink control information preceding the second stage sidelink control information comprises an indication [e.g., indicator bit] [e.g., indicating the transmission of the one out of the first sensing information and the second sensing information, the updated sensing information, and the combined sensing information in the second stage sidelink control information, SCI]]],
a transmission of an information element, IE, [e.g., MeasurementReportSidelink information element],
a transmission of a hybrid automatic repeat request, HARQ, feedback,
a transmission of a broadcasting message [e.g., LTE mode 3 measurement report information element].

In embodiments, the transmission of the second sidelink transmission and/or a periodicity of the transmission of the second sidelink transmission depends on at least one out of
a type of the second transceiver and/or the third transceiver [e.g. P-UE or V-UE],
a battery level of the second transceiver and/or the third transceiver,
a velocity of the second transceiver and/or the third transceiver,
a reception of cooperation request requesting a sharing of the sensing information,
a quality of service or quality requirement of the second transceiver and/or the third transceiver, and/or of a priority of traffic of the third transceiver,
a social's or operator's credit [e.g., for sharing or relaying sensing information],
a geo-location of second transceiver and/or the third transceiver.

In embodiments, the second sidelink transmission or another sidelink transmission [e.g., of the second transceiver [e.g., P-UE 1] or of a third transceiver] is performed using selected resources selected out of the first set of resources and/or the second set of resources based on the out of
the first sensing information and the second sensing information,
the updated sensing information,
the combined sensing information,
only based on the first sensing information.

In embodiments, the method further comprises performing a third sidelink transmission by the third transceiver [e.g., P-UE 2], wherein the third sidelink transmission is performed using selected resources selected out of the first set of resources and/or the second set of resources based on the one out of
the first sensing information and the second sensing information,
the updated sensing information,
the combined sensing information.

In embodiments, the first sensing information describes an occupancy [e.g., energy level [e.g., RSRP or RSSI]] only of the proper subset [e.g., Sa] of the first set of resources of the sidelink, the proper subset [e.g., Sa] of the first set of resources including [e.g., only] those resources of the first set of resources fulfilling an occupancy criterium [e.g., energy level [e.g., RSRP or RSSI] equal to or smaller than a predefined threshold] or a set of free resources [e.g. available and not used] or set of resources that are not free [e.g. used by other UEs or energy level above a certain threshold or collision occurred in them or not appropriate for a communication].

In embodiments, the first sensing information describes
a set of free resources that are not utilized by the first transceiver,
a set of resources that are recommended to be used,
a set of resources that are not recommended to be used,
a set of occupied resources,
one or more resources in which a collision is detected.

In embodiments, the second sensing information describes an occupancy [e.g., energy level [e.g., RSRP or RSSI]] only of the proper subset [e.g., Sa] of the second set of resources of the sidelink, the proper subset [e.g., Sa] of the second set of resources including [e.g., only] those resources of the second set of resources fulfilling an occupancy criterium [e.g., energy level [e.g., RSRP or RSSI] equal to or smaller than a predefined threshold] or a set of free resources [e.g. available and not used] or set of resources that are not free [e.g. used by other UEs or energy level above a certain threshold or collision occurred in them or not appropriate for communication].

In embodiments, the second sensing information describes
a set of free resources that are not utilized by the second transceiver,
a set of resources that are recommended to be used,
a set of resources that are not recommended to be used,
a set of occupied resources,
one or more resources in which a collision is detected.

In embodiments, the method further comprises transmitting, by the second transceiver [e.g., P-UE ], a sensing information sharing request [e.g., sidelink transmission with a sensing information sharing request] from the second transceiver to the first transceiver [e.g., V-UE ], the sensing information sharing request requesting a sharing of the sensing information of the first transceiver, wherein the first sidelink transmission is transmitted by the first transceiver to the second transceiver in response to the sensing information sharing request.

In embodiments, the method further comprises: transmitting, by the third transceiver [e.g., P-UE 2], a sensing information sharing request [e.g., sidelink transmission with a sensing information sharing request] from the third transceiver to the second transceiver [e.g., P-UE 1], the sensing information sharing request requesting a sharing of the sensing information of the second transceiver, wherein the second sidelink transmission is transmitted by the second transceiver to the third transceiver in response to the sensing information sharing request.

In embodiments, the sensing information request is transmitted by the second transceiver and/or the third transceiver in dependence on at least one out of
a battery level of the respective transceiver,
a reliability requirement of the respective transceiver or of an application of the respective transceiver,
a latency requirement of the respective transceiver or of an application of the respective transceiver.

In embodiments, the sensing information request is transmitted using at least one out of
a discovery procedure [e.g. sidelink discovery procedure],
an extended sidelink control information, SCI.

In embodiments, the first sidelink transmission and/or the second sidelink transmission is a sidelink transmission, for example for groupcast.

In embodiments, the first sidelink transmission and/or the second sidelink transmission is a groupcast sidelink transmission.

In embodiments, the groupcast sidelink transmission either comprises a control information or implicitly demand by sharing sensing information forcing transceivers that receive the groupcast sidelink transmission to stop performing a continuous or partial sensing.

In embodiments, the first sidelink transmission is transmitted by the first transceiver in response to an external event or in response to a reception of a sensing information sharing request [e.g., received from one transceiver of the at least two transceivers of the wireless communication system, such as a fixed [e.g., non-mobile] transceiver, such as a road side unit, RSU].

In embodiments, the second sidelink transmission is transmitted by the second transceiver in response to a condition or in response to a reception of a sensing information sharing request [e.g., received from one transceiver of the at least two transceivers of the wireless communication system, such as a fixed [e.g., non-mobile] transceiver, such as a road side unit, RSU, or a mobile transceiver [e.g., a mobile RSU]].

In embodiments, the condition is one out of
a geo-location of the respective transceiver,
a type of the respective transceiver or of another transceiver in vicinity to the respective transceiver,
a battery level of the respective transceiver or of another transceiver in vicinity to the respective transceiver,
a velocity the respective transceiver or of another transceiver in vicinity to the respective transceiver,
a quality of service or priority.

In embodiments, the first set of resources and the second set of resources are different sets of resources or partially overlapping sets of resources.

In embodiments, the second set of resources on which partial sensing is performed with the second transceiver depends on at least one out of
resources covered by the first sensing information,
a partial sensing pattern.

In embodiments, the partial sensing pattern depends on at least one out of
a battery level of the first or second transceiver,
a number [e.g., density] of other transceivers in the vicinity of the second transceiver,
a pattern number allocated to the second transceiver or received from another transceiver of the at least two transceivers of the wireless communication system, the pattern number indicating the partial sensing pattern out of a set of different partial sensing patterns [e.g., wherein the partial sensing patterns of the set of partial sensing patterns do not overlap or partially overlap],
resources covered by the first sensing information.

In embodiments, the method further comprises performing, with a third transceiver, a continuous or partial sensing of a third set of resources [e.g., sub-channels, a resource pool or a bandwidth part] of the sidelink, in order to obtain a third sensing information, the third sensing information describing an occupancy [e.g., energy level [e.g., RSRP or RSSI]] of at least a proper subset [e.g., Sa] of the third set of resources of the sidelink, performing a third sidelink transmission from the third transceiver to the second transceiver [e.g., P-UE ], wherein the third sidelink transmission comprises the third sensing information, performing a second sidelink transmission or groupcast sidelink transmission with the second transceiver, the second sidelink transmission or groupcast transmission comprising
the first sensing information and the third sensing information,
or an information derived from the first sensing information and the third sensing information.

In embodiments, the first or second sidelink transmission or groupcast sidelink transmission [e.g., relaying the first and/or second sensing information or the information derived therefrom] is transmitted by the first or second transceiver or any transmitter within a groupcast communication in dependence on at least one out of
a geographical area [e.g. the same and/or adjacent validity area(s), the same and/or adjacent and/or nearby zone(s), the same and/or neighbor and/or close by cell(s)] the sensing information contained in the first or second sidelink transmission or groupcast sidelink transmission is to be considered,
other parameters [e.g., relative distance or range between the transceivers, e.g., sidelink positioning, same group using groupcast or being in an adhoc group].

In embodiments, the method further comprises performing, with the second transceiver, a continuous or partial sensing of a second set of resources of the sidelink, in order to obtain a second sensing information, the second sensing information describing an occupancy [e.g., energy level [e.g., RSRP or RSSI]] of at least a proper subset of the second set of resources of the sidelink, wherein the second sidelink transmission comprises one out of:
the first sensing information, the second sensing information and the third sensing information,
a combined sensing information derived from a combination of the first sensing information, the second sensing information and the third sensing information,
an updated sensing information obtained by updating at least one out of the first sensing information and the second sensing information based on the third sensing information.

In embodiments, the second transceiver is UE, e.g. a battery-operated UE.

In embodiments, the second transceiver is, for example, a vulnerable road user equipment, VRU-UE [e.g., a pedestrian UE] or a vehicular mounted UE [e.g., V-UE].

In embodiments, the method further comprises: receiving, with the first transceiver, a first assistance information from the second transceiver, the first assistance information indicating a set of resources preferred or not preferred for a reception of the first sidelink transmission; and selecting, with the first transceiver, a set of resources for the first sidelink transmission in dependence on the first assistance information.

In embodiments, the method further comprises: receiving, with the second transceiver, a second assistance information from the third transceiver, the second assistance information indicating a set of resources preferred or not preferred for a reception of the second sidelink transmission; and selecting, with the second transceiver, a set of resources for the second sidelink transmission in dependence on the second assistance information.

In embodiments, the first sidelink transmission is transmitted by the first transceiver in response to a fulfillment of a first cooperative sensing condition.

In embodiments, the first cooperative sensing condition is at least one out of
a reception of a cooperative sensing request from the second transceiver,
a number of HARQ feedbacks [e.g., NACK],
a low RSS, RSRP at a receiver,
a high congestion,
a geographical location,
a QoS requirement in a transmitter,
a monitored QoS in a receiver.

In embodiments, the second sidelink transmission is transmitted by the second transceiver in response to a fulfillment of a second cooperative sensing condition.

In embodiments, the first cooperative sensing condition is at least one out of
a reception of a cooperative sensing request from the second transceiver,
a number of HARQ feedbacks [e.g., NACK],
a low RSS, RSRP at a receiver,
a high congestion,
a geographical location,
a QoS requirement in a transmitter,
a monitored QoS in a receiver.

Further embodiments provide a first transceiver of a wireless communication system, wherein the first transceiver is configured to operate in a sidelink in-coverage, out of coverage or partial coverage scenario [e.g., NR sidelink mode [e.g., mode 1 or mode 2]], in which the transceiver is configured or preconfigured to allocate or schedule resources for a sidelink communication [e.g., transmission and/or reception] over a sidelink autonomously or network controlled, wherein the first transceiver is configured to perform a continuous or partial sensing of a first set of resources [e.g., sub-channels, a resource pool or a bandwidth part] of the sidelink, in order to obtain a first sensing information, the first sensing information describing an occupancy of at least a proper subset of the first set of resources of the sidelink, wherein the first transceiver is configured to perform a first sidelink transmission from the first transceiver to a second transceiver of the wireless communication system, wherein the first sidelink transmission comprises the first sensing information.

Further embodiments provide a second transceiver of a wireless communication system, wherein the second transceiver is configured to operate in a sidelink in-coverage, out of coverage or partial coverage scenario [e.g., NR sidelink mode [e.g., mode 1 or mode 2]], in which the transceiver is configured or preconfigured to allocate or schedule resources for a sidelink communication [e.g., transmission and/or reception] over a sidelink autonomously or network controlled, wherein the second transceiver is configured to receive a first sidelink communication from a first transceiver of the wireless communication system, the first sidelink communication comprising a first sensing information, the first sensing information describing an occupancy of at least a part of a proper subset of resources of the sidelink, wherein the second transceiver is configured to perform a second sidelink transmission from the second transceiver to a third transceiver of the wireless communication system, wherein the second sidelink transmission comprises the first sensing information or an information derived therefrom.

In embodiments, the second transceiver is further configured to perform a continuous or partial sensing of a second set of resources of the sidelink, in order to obtain a second sensing information, the second sensing information describing an occupancy of at least a proper subset of the second set of resources of the sidelink, wherein the second sidelink transmission comprises:
the first sensing information and the second sensing information,
an updated sensing information obtained by updating the first sensing information based on the second sensing information,
a combined sensing information derived from a combination of the first sensing information and the second sensing information,

wherein the first set of resources and the second set of resources are the same sets of resources, different sets of resources or partially overlapping sets of resources.

Further embodiments provide a method for sharing sensing information with a first transceiver [e.g., V-UE 1] of a wireless communication system, the first transceiver operating in a sidelink in-coverage, out of coverage or partial coverage scenario [e.g., NR sidelink mode [e.g., mode 1 or mode 2]], in which resources for a sidelink communication [e.g., transmission and/or reception] over a sidelink are pre-configured by the wireless communication system or allocated or scheduled autonomously by the at least two transceivers, the method comprising: performing a continuous or partial sensing of a first set of resources [e.g., sub-channels, a resource pool or a bandwidth part] of the sidelink, in order to obtain a first sensing information, the first sensing information describing an occupancy of at least a proper subset of the first set of resources of the sidelink; performing a first sidelink transmission from the first transceiver to a second transceiver of the wireless communication system, wherein the first sidelink transmission comprises the first sensing information.

Further embodiments provide a method for sharing sensing information with a second transceiver [e.g., P-UE 1] of a wireless communication system, the second transceiver operating in a sidelink in-coverage, out of coverage or partial coverage scenario [e.g., NR sidelink mode [e.g., mode 1 or mode 2]], in which resources for a sidelink communication [e.g., transmission and/or reception] over a sidelink are pre-configured by the wireless communication system or allocated or scheduled autonomously by the at least two transceivers, the method comprising: receiving a first sidelink communication from a first transceiver of the wireless communication system, the first sidelink communication comprising a first sensing information, the first sensing information describing an occupancy of at least a proper subset of resources of the sidelink; performing a second sidelink transmission from the second transceiver to a third transceiver of the wireless communication system, wherein the second sidelink transmission comprises the first sensing information or an information derived therefrom.

Further embodiments provide a first transceiver of a wireless communication system, wherein the first transceiver is configured to operate in a sidelink in-coverage, out of coverage or partial coverage scenario [e.g., NR sidelink mode [e.g., mode 1 or mode 2]], in which resources for a sidelink communication [e.g., transmission and/or reception] over a sidelink are pre-configured by the wireless communication system or allocated or scheduled autonomously by the first transceiver, wherein the first transceiver is configured to perform a continuous or partial sensing of a first set of resources [e.g., sub-channels, a resource pool or a bandwidth part] of the sidelink, in order to obtain a first sensing information, the first sensing information describing an occupancy [e.g., based on energy level [e.g., RSRP or RSSI]] of at least a proper subset [e.g., Sa] of the first set of resources of the sidelink, wherein the first transceiver is configured to perform a first sidelink transmission to a second transceiver of the wireless communication system, wherein the first sidelink transmission comprises the first sensing information.

In embodiments, the first transceiver is configured to receive a sidelink transmission from the second transceiver or another transceiver of the wireless communication system, wherein the sidelink transmission is performed using selected resources selected [e.g., only] out of the first set of resources [e.g., only] based on the first sensing information or an information derived therefrom.

Further embodiments provide a second transceiver of a wireless communication system, wherein the second transceiver is configured to operate in a sidelink in-coverage, out of coverage or partial coverage scenario [e.g., NR sidelink mode [e.g., mode 1 or mode 2]], in which resources for a sidelink communication [e.g., transmission and/or reception] over a sidelink are pre-configured by the wireless communication system or allocated or scheduled autonomously by the first transceiver, wherein the second transceiver is configured to receive a first sidelink transmission from a first transceiver of the wireless communication system, wherein the first sidelink transmission comprises the first sensing information, wherein the second transceiver is configured to perform a second sidelink transmission to a third transceiver of the wireless communication system, wherein the second sidelink transmission comprises the first sensing information or an information derived therefrom.

In embodiments, the second transceiver is configured to relay the first sensing information by means of the second sidelink transmission to the third transceiver.

In embodiments, the second transceiver is configured to perform a continuous or partial sensing of a second set of resources of the sidelink, in order to obtain a second sensing information, the second sensing information describing an occupancy [e.g., energy level [e.g., RSRP or RSSI]] of at least a proper subset of the second set of resources of the sidelink, wherein the second sidelink transmission comprises one out of
the first sensing information and the second sensing information,
an updated sensing information obtained by updating the first sensing information based on the second sensing information,
a combined sensing information derived from a combination of the first sensing information and the second sensing information.

Further embodiments provide a second transceiver of a wireless communication system, wherein the second transceiver is configured to operate in a sidelink in-coverage, out of coverage or partial coverage scenario [e.g., NR sidelink mode [e.g., mode 1 or mode 2]], in which resources for a sidelink communication [e.g., transmission and/or reception] over a sidelink are pre-configured by the wireless communication system or allocated or scheduled autonomously by the first transceiver, wherein the second transceiver is configured to receive a first sidelink transmission from a first transceiver of the wireless communication system, wherein the first sidelink transmission comprises a first sensing information, the first sensing information describing an occupancy [e.g., based on energy level [e.g., RSRP or RSSI]] of at least a proper subset [e.g., Sa] of a first set of resources of the sidelink, wherein the second transceiver is configured to perform a second sidelink transmission to the first transceiver or another transceivers of the wireless communication system, wherein the second sidelink transmission is performed using selected resources selected out of the first set of resources only based on the first sensing information.

Further embodiments provide a wireless communication system comprising a first transceiver and a second transceiver.

In embodiments, UEs do (or are configured to perform) sensing/partial sensing based on the higher layers configuration.

In embodiments, a UE shares (or is configured to share) the results of its sensing procedure (for example, a set of measurements from resources or set of resources which a UE is not utilized or recommend to other UE(s) to utilize or the UE does not recommend other UE(s) to utilize) or relays (or is configured to relay) the received sensing results (for example a set of measurements from resources or set of resources which a UE is not utilized or recommend to other UE(s) to utilize or the UE does not recommend other UE(s) to utilize) of other UEs with/without integration of them with its own sensing results or obtained resources applying for example one (or more) of the following options:
A field in the 1^{st} stage SCI format 0-1 indicating a set of contiguous unoccupied resources in time and frequency, or a bitmap
A field in the 2^{nd} stage SCI and an indicator bit in the 1^{st} stage SCI
A field in the “MeasurementReportSidelink”IE
A field in HARQ feedback for example when two UEs participate in an ongoing session and the receiver takes over the sensing and shares it sensing results in the HARQ feedback over Physical Sidelink Feedback Channel (PSFCH)
Broadcasting LTE mode 3 measurement report IE by UEs over PSCCH. UEs usually transmit this IE over Physical Uplink Control Channel (PUCCH) to report sensing results to eNodeB

In embodiments, the conditions and the periodicity of sharing sensing results with other UEs in the proximity depend on at least one parameter, examples of parameters are:
Type of UEs: V-UEs may do continuous sensing and share their sensing results
Battery level of UEs: battery-based UEs with high remaining battery level may do sensing and share their results. The periodicity of sharing may also depend on the battery level e.g., the higher the battery level, the higher frequency of sharing
Velocity of UEs: slower V-UE may generate more valid sensing results as the sensing information is location-dependent. On the other hand, faster UEs may need more cooperation due to the QoS requirements.
Reception of cooperation request: a UE may start sharing/relaying sensing information with other UEs in the proximity by reception of a cooperation request from UEs or from a Road Side Unit (RSU)
Quality of service requirement of UEs/priority of traffic: a UE may realize high priority traffic from other UEs in the proximity by decoding SCI. In this case, the UE makes more cooperation by sharing its sensing results more frequent to assist other UEs in the proximity
A social/operator's credit as an incentive to share sensing information e.g the higher cooperation, the more benefit
Geo-location: UEs may start cooperation in some specific geo-locations, e.g., junctions

In embodiments, P-UEs may optionally request for cooperation of other UEs in the proximity if they are at least in one of the following states:
Low battery level, e.g., battery level below X% of the capacity of the battery. Wherein, for example, x can be selected form a set of {10,20, . . . ,50}.
High reliability/low latency requirements of an application

In embodiments, P-UEs may optionally request for cooperation applying at least one of the following options:
Discovery procedure
Sending SCI with a field to indicate the request for cooperation (sharing/relaying sensing information)
Adding a field in HARQ feedback indicating the request for cooperation (sharing/relaying sensing information)

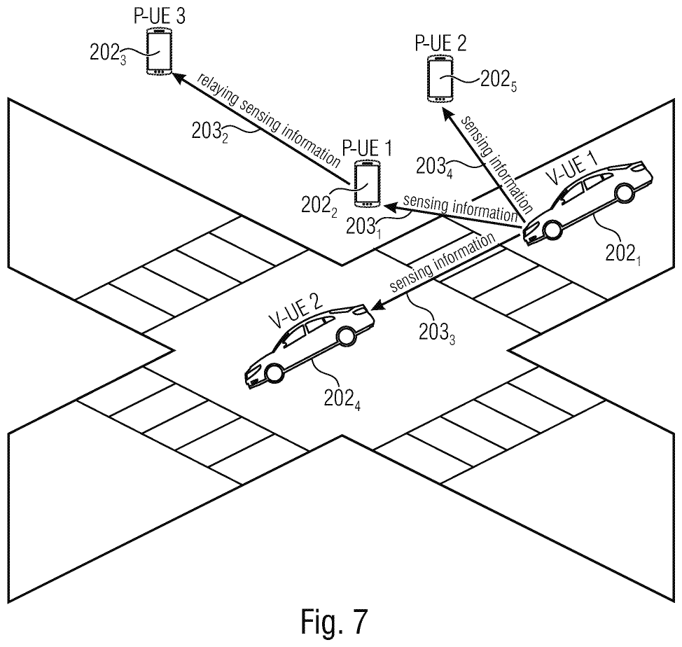

FIG. 7 shows an illustrative view of an example for cooperative sensing by sharing/relaying sensing results. In detail, FIG. 7 shows a schematic representation of a wireless communication system comprising a first transceiver 202₁, like a UE (e.g., V-UE), and a second transceiver 202₂, like a UE (e.g., P-UE 1).

The first transceiver 202₁ can be configured to perform a continuous or partial sensing of a first set of resources of the sidelink, in order to obtain a first sensing information, the first sensing information describing an occupancy of at least a proper subset of the first set of resources of the sidelink, and to perform a first sidelink transmission 203₁ from the first transceiver 202₁ (e.g., V-UE 1) to the second transceiver 202₂ (e.g., P-UE 1) of the at least two transceivers, wherein the first sidelink transmission 203₁ comprises the first sensing information.

The second transceiver 202₂ (e.g., P-UE 1) can be configured to perform a second sidelink transmission 203₂ to a third transceiver 202₃ (e.g., P-UE 3), wherein the second sidelink transmission 203₂ comprises the first sensing information or an information derived therefrom. For example, the second transceiver 202₂ (e.g., P-UE 1) can be configured to relay the first sensing information to the third transceiver 202₃ (e.g., P-UE 3) by means of the second sidelink transmission 203₂. For example, the second transceiver 202₂ (e.g., P-UE 1) can be configured to perform a continuous or partial sensing of a second set of resources of the sidelink, in order to obtain a second sensing information, the second sensing information describing an occupancy of at least a proper subset of the second set of resources of the sidelink, wherein the second sidelink transmission comprises one out of (1) the first sensing information and the second sensing information, (2) an updated sensing information obtained by updating the first sensing information based on the second sensing information, (3) a combined sensing information derived from a combination of the first sensing information and the second sensing information, wherein the first set of resources and the second set of resources are the same sets of resources, different sets of resources or partially overlapping sets of resources.

Further, the first transceiver 202₁ (e.g., V-UE 1) naturally can also be configured to perform a third sidelink 203₃ transmission to a fourth transceiver 202₄ (e.g., V-UE2), the third sidelink 203₃ transmission comprising the first sensing information, and/or a fourth sidelink 203₄ transmission to a fifth transceiver 202₅ (e.g., P-UE 2), the third sidelink 203₃ transmission comprising the first sensing information. The first sidelink transmission 203₁, the third sidelink 203₃ transmission and the fourth sidelink transmission 203₄ could also be performed by means of a multicast transmission to the second transceiver 202₂, the fourth transceiver 2024 and the fifth transceiver 202₅.

In other words, FIG. 7 shows an example V-UE 1 as a UE which cooperates with other UEs in the proximity by sharing its sensing information (for example, to P-UE1). P-UE 1 also relays the received sensing information from V-UE 1. P-UE 1 may do sensing itself and integrate its sensing information with information received from V-UE 1 and then forward them to other UEs or just forward the received information from V-UE 1. All P-UEs in this scenario may save energy by minimizing their sensing and V-UEs may improve their resource selection obtaining more information from the radio spectrum.

Subsequently, embodiments of the present invention are described in further detail.

### Embodiment 1: Cooperative Sensing by Sharing/Relaying Sensing Results

In embodiments, UEs share (or are configured to share) their sensing information and/or relay (or are configured to relay) received sensing information from other UEs to cooperate, aiming on energy saving in battery-dependent UEs and increasing the reliability and reducing the latency in sidelink communication. Relay UEs may integrate the received sensing information with each other or with their own sensing information before relaying the information.

In embodiments, additionally or alternatively UEs share (or are configured to share) a set of resources (e.g., a set of free/busy resources or a set of resources that causes a collision at UE B, for example, due to the hidden terminal problem/half duplex problem or a set of resources that are not utilized due to the exposed terminal problem) or relay (or are configured to relay) received sensing information from other UEs or from a RSU or gNB to the intended receiver(s), e.g, UE B, aiming at energy saving and increasing the reliability and reducing the latency in sidelink communication and increasing spectral efficiency. Relay UEs may integrate the received sensing information with each other or with their own sensing information before relaying the information.

For example, a UE undertakes the following steps to cooperate with other UEs:
The UE makes the Sa list based on its sensing/partial sensing and may report it to the higher layers
The UE may receive the selected resources by the higher layer and may exclude them from Sa
The UE may select a set or all of the resources from Sa to report to other UEs in the proximity
The UE may send the list from previous step to UEs in the proximity by broadcasting/unicasting or groupcasting/geocasting

Or for example undertakes the following steps:
UE realize a set of free resources and it has not anything to transmit
UE cooperate with other UEs by indicating the free resources in 1^{st} SCI or 2^{nd} SCI

Or for example a UE undertakes the following steps:
A UE identifies a set of free or busy resources through its own sensing or receiving information from other UEs/gNB
The UE informs other UEs about a set of resources that the UE prefers or not prefers to be monitored for reception
The UE might inform other UEs about collisions or ongoing sidelink communication on some resources to avoid collision (e.g. due to hidden terminal problem, or half duplex problem)
The UE assists other UEs with cooperative messages to improve the utilization of spectrum for example due to exposed terminal problem

Or for example a UE undertakes the following steps:
A UE senses a collision on some resources
The UE provides a set of resources on which collision has occurred
The UE shares a set of resources (resulted from the sensing) with other UEs about the resources which it recognized any collision
A collision may occur on resources which a UE is receiving or on any resources which other UEs are communicating

In embodiments, the UE which shares the coordination/cooperative/sensing information/messages (e.g., set of resources, sensing results, preferred/not preferred resources, existing or possible collisions in a set of resources) might be the intended receiver, i.e., the UE monitoring the resources for reception on the resources or not.

### Embodiment 2: Sharing Sensing Information

In embodiments, the results of the sensing procedure can be shared with other UEs using for example one of the following options:
Using SCI
   For example, introducing an enhanced 1^{st} stage SCI format 0-1 adding one or several fields to share sensing results. The new fields may report sensing results for example as follows:
      A bit map to indicate resources with received signal strength below or above the specified threshold where the threshold is defined by higher layers.
      A bit map to indicate blocks of resources which are sensed as unoccupied by a UE. A block of resources might be pre-defined and refers to L contiguous sub-channels within M contiguous single-slot resources.
   For example introducing an enhanced 1^{st} stage SCI format 1 adding a bit which indicates the sensing results in the 2^{nd} stage SCI. One or several fields might be added in 2^{nd} stage SCI same as the fields which were mentioned for the 1^{st} stage SCI to share the sensing results.
   For example, there could be a new format for 1^{st} stage or 2^{nd} stage SCI having one or several fields for cooperation of UEs i.e. sensing information (e.g. sensing results or set of resources).
   For example, the new 1^{st} or 2^{nd} stage SCI format might depend on cast type
Using MeasurementReportSidelink IE by adding one or multiple fields to it. The triggering conditions for this MeasureReportSlidelink IE can be based on multiple factors e.g. QoS or priority of the application supported, availability of sensing results, battery level of the UE etc. The example of the corresponding 5 MeasurementReportSidelink Information Element, IE, could be as follows. Thereby, in the below example, elements being highlighted in yellow may be provided, modified or changed according to the inventive approach described herein.

| | |
|---|---|
| - | -- TAG-MEASUREMENTREPORTSIDELINK-START |

-

| - | MeasurementReportSidelink ::= | SEQUENCE { |
|---|---|---|
| - | criticalExtensions | CHOICE { |
| - | measurementReportSidelink-r16 | MeasurementReportSidelink-IEs- |
| | r16, | |
| - | criticalExtensionsFuture | SEQUENCE { } |

| | |
|---|---|
| - | } |
| - | } |

-

| - | MeasurementReportSidelink-IEs-r16 ::= | SEQUENCE { |
|---|---|---|
| - | sl-measResults-r16 | SL-MeasResults-r16, |
| - | lateNonCriticalExtension | OCTET STRING |
| | OPTIONAL, | |
| - | nonCriticalExtension | SEQUENCE{ } |

| | |
|---|---|
| | OPTIONAL |
| - | } |

-

| | | |
|---|---|---|
| - | SL-MeasResults-r16 ::= | SEQUENCE { |
| - | sl-MeasId-r16 | SL-MeasId-r16, |
| - | sl-MeasResult-r16 | SL-MeasResult-r16, |

| | |
|---|---|
| - | . . . |
| - | } |

-

| | | |
|---|---|---|
| - | SL-MeasResult-r16 ::= | SEQUENCE { |
| - | sl-ResultDMRS-r16 | SL-MeasQuantityResult-r16 |

| | |
|---|---|
| | OPTIONAL, |
| - | . . . |
| - | } |

-

| - | SL-MeasQuantityResult-r16 ::= | SEQUENCE { |
|---|---|---|
| - | sl-RSRP-r16 | RSRP-Range |
| | OPTIONAL, | |
| - | . . . | |
| - | } | |
| - | - SL-SensingResults-r* ::= | SEQUENCE { ... . . RSRP-Range/ RSSI-Range |
| | OPTIONAL, | |
| | ... . | |
| | } | |
| - | - SL-PartialSensingResults-r* ::= | SEQUENCE { ... . . RSRP-Range/ |

RSSI-Range
OPTIONAL,
... .

-

| | |
|---|---|
| - | -- TAG-MEASUREMENTREPORTSIDELINK-STOP |
| - | -- ASN1STOP |

Using measurement report message which is used in LTE mode 3 by UEs to the sent to eNodeB, an example is shown below [36.331]:

| MeasResultSensing-r15 ::= | SEQUENCE { |
|---|---|
| sl-SubframeRef-r15 | INTEGER (0..10239), |
| sensingResult-r15 | SEQUENCE (SIZE (0..400)) OF |
| | SensingResult-r15 |
| } | |
| SensingResult-r15 ::= | SEQUENCE { |
| resourceIndex-r15 | INTEGER (1..2000) |
| } | |
| UnusedResourceIndex:: = | SEQUENCE{ |
| UnusedresourceIndex-r17 | INTEGER(1...X) OPTIONAL |

}

where, Xis in between 1-2000.

The results of the sensing procedure might be shared with all UEs receiving the result of the sensing procedure from the sharing UE or might be shared with those UEs only, when at least one of the following conditions applies:
The UE is located in the proximity or in a nearby geographical position with the sharing UE, e.g. within the same zone or within a group of e.g. adjacent zones, within the same or an adjacent/nearby validity area, within the same cell or within a group of cells (e.g. neighbor cells, cells in proximity)
The UE is located within a given relative distance to the sharing UE
The UE is member of the same group as the sharing UE (e.g. based on groupcast or in a kind of adhoc group, e.g. a proximity based group or based on an RSU in proximity to both UEs.
A UE which has established a PC5-RRC connection (e.g for unicast link) with the UE

### Embodiment 3: Triggering a Cooperation

In embodiments, a UE may ask other UEs in the proximity to share their sensing information using for example one of the following options:
Through discovery procedure:
   UEs initiate the discovery procedure and request for sharing same as Model B, i.e. “who is there?”/“are you there?”. Other UEs in the proximity such as V-UEs or UEs with enough battery level start to share sensing information using at least one of the options mentioned above in embodiment 2.
Through an extended SCI to trigger cooperation:
   One bit in SCI could indicate the need for cooperation. This bit can be set by any UE.
Case of Groupcast or group of UEs, for example:
   One member UE in the group (e.g. group head or any other UE of the group) could
      sense and share the results for the complete group or
      trigger cooperation with other group members same as FIG. 7. In case of cooperation, one group member UE may inform the other group member UEs, which resources to sense and possibly to share the sensing results (coordinated sensing).
   E.g., the group head takes over the sensing and shares the results automatically. Other group member UEs may be informed to stop sensing, while another UE shares the sensing results.
   A UE [e.g. group head] may choose a UE to do sensing and sharing the sensing information and stop all other UEs in the group from sensing.
   A group of UEs could be any or multiple (more than 1) of UEs in proximity (e.g. close to a junction). The group could be e.g. a kind of ad hoc group, e.g. based on proximity only or based on using a similar or the same service or application in the proximity.
   A receiver UE may share its preference with transmitter UE(s) about the resources to receive or not to receive on some resources

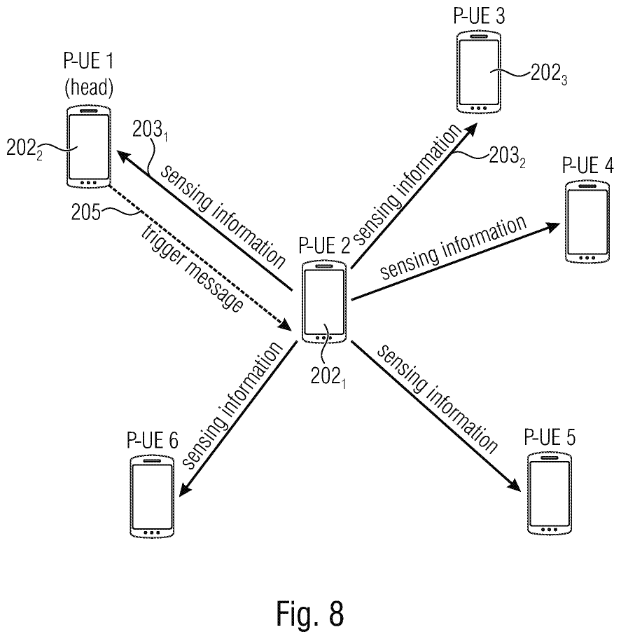

FIG. 8 shows a schematic representation of a wireless communication system comprising a first transceiver 202₁, like a UE (e.g., P-UE 2) and a second transceiver 202₂, like a UE (e.g., P-UE 1). The second transceiver 202₂ (e.g., P-UE 1) can be configured to transmit a sensing information sharing request 205 (e.g., a sidelink transmission with a sensing information sharing request) to the first transceiver 202₁ (e.g., P-UE 2), the sensing information sharing request 205 requesting a sharing of the sensing information of the first transceiver 202₁ (e.g., P-UE 2), wherein the first transceiver 202₁ (e.g., P-UE 2) is configured to perform the first sidelink transmission 203₁ to the second transceiver 202₂ (e.g., P-UE 1) and optionally also to other transceivers of the wireless communication system, such as to at least a third transceiver 202₃, like a UE (e.g., P-UE 3), of the wireless communication system.

In other words, FIG. 8 shows an illustrative view of an example of triggering cooperation by a group head. In embodiments, triggering a cooperation might be restricted and might only be allowed meeting one or more conditions. The examples of such conditions are:
Low battery status
Other UEs in proximity
Only for high priority transmission
Geo-location conditions e.g. UEs are close to a junction

### Embodiment 4: Decision to Response to a Cooperation Trigger/Start of Cooperation

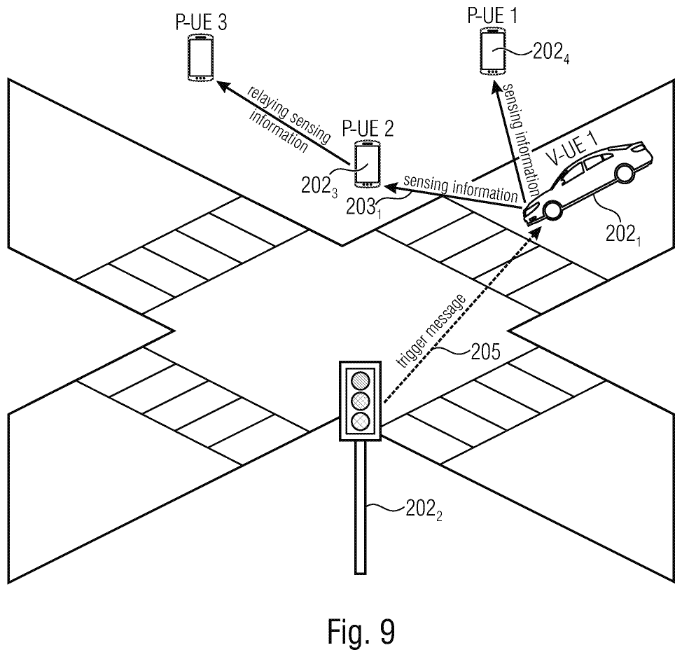

In embodiments, UEs may start sharing (or be configured to start sharing) sensing results with/without receiving a cooperation request based on Embodiment 3 and/or on one or any number conditions. The conditions might be:
Based on the geo-location or indication from RSU as shown in FIG. 9
Type of UE (e.g. V-UE/P-UE)
Battery level and or battery capacity of UEs
Velocity of UEs
QoS/priority: only for requests received exceeding a priority threshold

FIG. 9 shows a schematic representation of a wireless communication system comprising a first transceiver 202₁, like a UE (e.g., V-UE 1) and a second transceiver 202₂, like a road side unit. The second transceiver 202₂ can be configured to transmit a sensing information sharing request 205 (e.g., a sidelink transmission with a sensing information sharing request) to the first transceiver 202₁ (e.g., V-UE 1), the sensing information sharing request 205 requesting a sharing of the sensing information of the first transceiver 202₁ (e.g., V-UE 1), wherein the first transceiver 202₁ (e.g., V-UE 1) is configured to perform the first sidelink transmission 203₁ to a third transceiver 202₃ (e.g., P-UE 1) and optionally also to other transceivers of the wireless communication system, such as to a fourth transceiver 2024, like a UE (e.g., P-UE 1), of the wireless communication system.

In other words, FIG. 9 shows an illustrative view of an example of a response to a cooperation trigger by a RSU.

### Embodiment 5: Cooperative Partial Sensing

This embodiment assumes that several UEs (usually P-UEs) perform partial sensing and share their sensing results to get the full sensing results. One possibility could be to consider cooperative partial sensing for UEs in groupcast. Each member UE of the group could sense a defined part of a resource pool or a defined resource pool. Free resources could be shared as defined in embodiment 2.

Examples of how to perform partial sensing are listed below:
P-UEs leave out partial sensing due to reception of enough sensing information from V-UEs or other P-UEs, which might be limited for a period or until it is regarded as outdated.
Pre-configured partial sensing patterns for P-UEs (by base station e.g. gNB) are for example:
   Patterns depending on battery charge level, e.g. full/medium/low battery level of P-UEs
   Patterns depending on UE density, e.g. for high/medium/low density of P-UEs
   Non-overlapping patterns to increase efficiency (or minimum overlapping)
   For example different resource pools for different P-UEs
Exchange of pattern indexes between UEs may be done through different options e.g. discovery procedure or SCI
P-UEs adapt their patterns to complement each other (sensing pattern selection), for example:
   If two P-UEs have the same pattern, the P-UE which started discovery (sent SCI) may keep its pattern and other P-UEs may change their pattern
   Based on decision of master UE in a group (for groupcast) or one of the UEs in a unicast communication (maybe covered by above description)

### Embodiment 6: Fusion of Sensing Information/Relaying Sensing Results

In embodiments, a P-UE or V-UE may just integrate received information from other UEs and broadcast them.

In Embodiments, a P-UE may offer relaying role to other P-UEs, e.g., a UE receives sensing information from a V-UE.

In embodiments, a P-UE or V-UE may just relay received sensing information from other UEs. For example, a validity zone of sensing information may be considered. For example, other parameters like the relative distance or range between the UEs, e.g., sidelink positioning, may be considered.

In embodiments, a UE may integrate its sensing results with the received sensing results from other UEs (e.g., exclusion of some resources, consideration of some resources) for its own resource selection or generation of new cooperative messages to be shared with other UEs.

In embodiments, a UE may do reselection on its selected resources for its transmissions based on the fusion of the received sensing information from other UEs and the outcome of its own sensing procedure.

### Embodiment 7: Cooperative Sensing Information for only Indicated Transmission Time Instances

In embodiments, in resource allocation Mode 2, a UE may transmit the sensing information if the nearby users request for only transmitting time instances indicated in the control information, when the cooperative sensing is configured by the higher layer signaling, e.g., RRC messages or SCI information.

### Embodiment 8: Events to Trigger Cooperation of UEs

In embodiments, the cooperation of UEs in form of exchanging sensing results or a set of resources to transmit/receive or not to transmit/receive can be triggered by at least one out of:
a number of HARQ feedbacks (e.g. NACK),
a low RSS, RSRP at a receiver,
a high congestion,
a geographical location,
a QoS requirement in a transmitter or monitored QoS in a receiver.

### Embodiment 9

In embodiments, a UE might use the received cooperative/coordination information from other UE(s) (e.g., set of resources, sensing results, information about existing/possible collision on some resources) and apply them in its resource (re-)selection.

In embodiments, the UE might do the resource selection only based on the received cooperative/coordination/sensing information from other UEs or based on its own sensing results and the received cooperative/coordination/sensing information.

### Further Embodiments

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

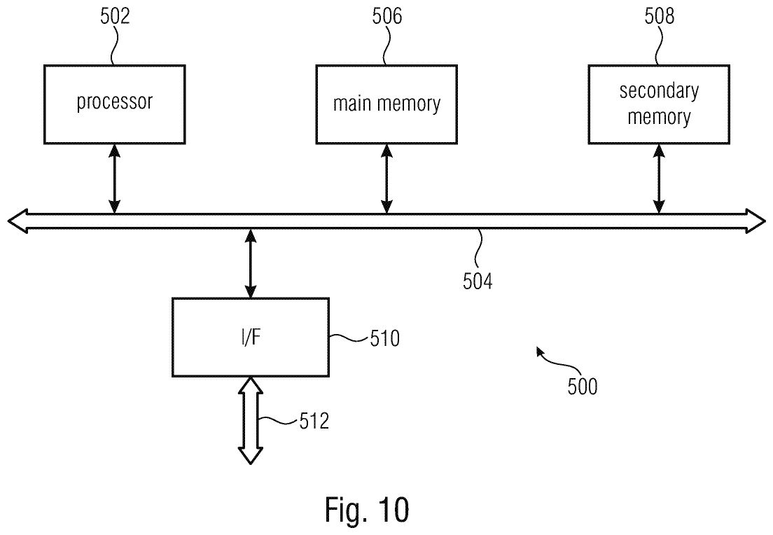

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 10 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the from electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

Depending on certain implementation requirements, embodiments of the invention can be implemented in hardware or in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitionary.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

The apparatus described herein may be implemented using a hardware apparatus, or using a computer, or using a combination of a hardware apparatus and a computer.

The apparatus described herein, or any components of the apparatus described herein, may be implemented at least partially in hardware and/or in software.

The methods described herein may be performed using a hardware apparatus, or using a computer, or using a combination of a hardware apparatus and a computer.

The methods described herein, or any components of the apparatus described herein, may be performed at least partially by hardware and/or by software.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] RP-193231: New WID on NR sidelink enhancement, December 2019

[2] TS 36.213

[3] TS 36.212

[4] TS 23.285

[5] TS 23.303

[6] TS 36.331

[7] TS 38.214

[8] TS 38.212
Abbreviations
VRU Vulnerable road user
DRX Discontinuous reception
V-UE Vehicular UE
P-UE Pedestrian UE: should not be limited to pedestrians, but represents any UE with a need to save power, e.g. electrical cars, cyclists

1. Method for sharing sensing information between at least two transceivers of a wireless communication system, the at least two transceivers operating in a sidelink in-coverage, out of coverage or partial coverage scenario, in which resources for a sidelink communication over a sidelink are pre-configured by the wireless communication system or allocated or scheduled autonomously by the at least two transceivers, the method comprising:
performing, with the first transceiver, a continuous or partial sensing of a first set of resources of the sidelink, in order to acquire a first sensing information, the first sensing information describing an occupancy of at least a proper subset of the first set of resources of the sidelink,
performing a first sidelink transmission from the first transceiver to a second transceiver of the at least two transceivers, wherein the first sidelink transmission comprises the first sensing information;
wherein the first sidelink transmission is a transmission of a second stage sidelink control information.

2. Method according to claim 1,
wherein the first sidelink transmission is one out of
a transmission of a first stage sidelink control information, SCI,
a transmission of an information element, IE,
a transmission of a hybrid automatic repeat request, HARQ, feedback transmission,
a transmission of a broadcasting message.

3. Method according to claim 1,
wherein the transmission of the first sidelink transmission and/or a periodicity of the transmission of the first sidelink transmission depends on at least one out of
a type of the first transceiver and/or the second transceiver,
a battery level of the first transceiver and/or the second transceiver,
a velocity of the first transceiver and/or the second transceiver,
a reception of cooperation request requesting a sharing of the sensing information,
a quality of service or quality requirement of the first transceiver and/or the second transceiver, and/or of a priority of traffic of the second transceiver,
a social's or operator's credit,
a geo-location of the first transceiver and/or the second transceiver.

4. Method according to claim 1,
wherein the method further comprises:
performing, with the second transceiver, a continuous or partial sensing of a second set of resources of the sidelink, in order to acquire a second sensing information, the second sensing information describing an occupancy of at least a proper subset of the second set of resources of the sidelink,
performing a second sidelink transmission from the second transceiver to the first or a third transceiver of the at least two transceivers, wherein the second sidelink transmission comprises one out of
the first sensing information and the second sensing information,
an updated sensing information acquired by updating the first sensing information based on the second sensing information,
a combined sensing information derived from a combination of the first sensing information and the second sensing information.
wherein the first set of resources and the second set of resources are the same sets of resources, different sets of resources or partially overlapping sets of resources.

5. Method according to claim 4,
wherein the second sidelink transmission is one out of
a transmission of a first stage sidelink control information, SCI,
a transmission of a second stage sidelink control information,
a transmission of an information element, IE,
a transmission of a hybrid automatic repeat request, HARQ, feedback,
a transmission of a broadcasting message.

6. Method according to claim 4,
wherein the transmission of the second sidelink transmission and/or a periodicity of the transmission of the second sidelink transmission depends on at least one out of
a type of the second transceiver and/or the third transceiver,
a battery level of the second transceiver and/or the third transceiver,
a velocity of the second transceiver and/or the third transceiver,
a reception of cooperation request requesting a sharing of the sensing information,
a quality of service or quality requirement of the second transceiver and/or the third transceiver, and/or of a priority of traffic of the third transceiver,
a social's or operator's credit,
a geo-location of second transceiver and/or the third transceiver.

7. Method according to claim 1,
wherein the first sensing information describes
a set of free resources that are not utilized by the first transceiver,
a set of resources that are recommended to be used,
a set of resources that are not recommended to be used,
a set of occupied resources,
one or more resources in which a collision is detected.

8. Method according to claim 4,
wherein the second sensing information describes
a set of free resources that are not utilized by the second transceiver,
a set of resources that are recommended to be used,
a set of resources that are not recommended to be used,
a set of occupied resources,
one or more resources in which a collision is detected.

9. Method according to claim 1,
wherein the first sidelink transmission is transmitted by the first transceiver in response to an external event or in response to a reception of a sensing information sharing request.

10. Method according to claim 1,
wherein the method further comprises:
receiving, with the first transceiver, a first assistance information from the second transceiver, the first assistance information indicating a set of resources preferred or not preferred for a reception of the first sidelink transmission,
selecting, with the first transceiver, a set of resources for the first sidelink transmission in dependence on the first assistance information.

11. Method according to claim 4,
wherein the method further comprises:
receiving, with the second transceiver, a second assistance information from the third transceiver, the second assistance information indicating a set of resources preferred or not preferred for a reception of the second sidelink transmission,
selecting, with the second transceiver, a set of resources for the second sidelink transmission in dependence on the second assistance information.

12. Method for sharing sensing information between at least two transceivers of a wireless communication system, the at least two transceivers operating in a sidelink in-coverage, out of coverage or partial coverage scenario, in which resources for a sidelink communication over a sidelink are pre-configured by the wireless communication system or allocated or scheduled autonomously by the at least two transceivers, the method comprising:
performing, with the first transceiver, a continuous or partial sensing of a first set of resources of the sidelink, in order to acquire a first sensing information, the first sensing information describing an occupancy of at least a proper subset of the first set of resources of the sidelink,
performing a first sidelink transmission from the first transceiver to a second transceiver of the at least two transceivers, wherein the first sidelink transmission comprises the first sensing information;
wherein the transmission of the first sidelink transmission and/or a periodicity of the transmission of the first sidelink transmission depends on at least one out of
a reception of cooperation request requesting a sharing of the sensing information,
a quality of service or quality requirement of the first transceiver and/or the second transceiver, and/or of a priority of traffic of the second transceiver,
a social's or operator's credit.

13. First transceiver of a wireless communication system, the first transceiver operating in a sidelink in-coverage, out of coverage or partial coverage scenario, in which resources for a sidelink communication over a sidelink are pre-configured by the wireless communication system or allocated or scheduled autonomously by the first transceiver, the method comprising:
performing a continuous or partial sensing of a first set of resources of the sidelink, in order to acquire a first sensing information, the first sensing information describing an occupancy of at least a proper subset of the first set of resources of the sidelink,
performing a first sidelink transmission from the first transceiver to a second transceiver of the wireless communication network, wherein the first sidelink transmission comprises the first sensing information;
wherein the first sidelink transmission is a transmission of a second stage sidelink control information.

14. Second transceiver of a wireless communication system, the second transceiver operating in a sidelink in-coverage, out of coverage or partial coverage scenario, in which resources for a sidelink communication over a sidelink are pre-configured by the wireless communication system or allocated or scheduled autonomously by the second transceiver, the method comprising:
receiving a first sidelink transmission from a first transceiver of the wireless communication network, wherein the first sidelink transmission comprises a first sensing information acquired by the first transceiver by performing a continuous or partial sensing of a first set of resources of the sidelink, the first sensing information describing an occupancy of at least a proper subset of the first set of resources of the sidelink;
wherein the first sidelink transmission is a transmission of a second stage sidelink control information.

15. Method for operating a first transceiver of a wireless communication system, the method comprising:
operating the first transceiver in a sidelink in-coverage, out of coverage or partial coverage scenario, in which resources for a sidelink communication over a sidelink are pre-configured by the wireless communication system or allocated or scheduled autonomously by the first transceiver,
performing a continuous or partial sensing of a first set of resources of the sidelink, in order to acquire a first sensing information, the first sensing information describing an occupancy of at least a proper subset of the first set of resources of the sidelink,
performing a first sidelink transmission from the first transceiver to a second transceiver of the wireless communication network, wherein the first sidelink transmission comprises the first sensing information,
wherein the first sidelink transmission is a transmission of a second stage sidelink control information.

16. Method for operating a second transceiver of a wireless communication system, the method comprising:
operating the second transceiver in a sidelink in-coverage, out of coverage or partial coverage scenario, in which resources for a sidelink communication over a sidelink are pre-configured by the wireless communication system or allocated or scheduled autonomously by the second transceiver,
receiving a first sidelink transmission from a first transceiver of the wireless communication network, wherein the first sidelink transmission comprises a first sensing information acquired by the first transceiver by performing a continuous or partial sensing of a first set of resources of the sidelink, the first sensing information describing an occupancy of at least a proper subset of the first set of resources of the sidelink;
wherein the first sidelink transmission is a transmission of a second stage sidelink control information.

17. A non-transitory digital storage medium having a computer program stored thereon to perform the method for operating a first transceiver of a wireless communication system, the method comprising:
operating the first transceiver in a sidelink in-coverage, out of coverage or partial coverage scenario, in which resources for a sidelink communication over a sidelink are pre-configured by the wireless communication system or allocated or scheduled autonomously by the first transceiver,
performing a continuous or partial sensing of a first set of resources of the sidelink, in order to acquire a first sensing information, the first sensing information describing an occupancy of at least a proper subset of the first set of resources of the sidelink,
performing a first sidelink transmission from the first transceiver to a second transceiver of the wireless communication network, wherein the first sidelink transmission comprises the first sensing information,
wherein the first sidelink transmission is a transmission of a second stage sidelink control information,
when said computer program is run by a computer.

18. A non-transitory digital storage medium having a computer program stored thereon to perform the method for operating a second transceiver of a wireless communication system, the method comprising:
operating the second transceiver in a sidelink in-coverage, out of coverage or partial coverage scenario, in which resources for a sidelink communication over a sidelink are pre-configured by the wireless communication system or allocated or scheduled autonomously by the second transceiver,
receiving a first sidelink transmission from a first transceiver of the wireless communication network, wherein the first sidelink transmission comprises a first sensing information acquired by the first transceiver by performing a continuous or partial sensing of a first set of resources of the sidelink, the first sensing information describing an occupancy of at least a proper subset of the first set of resources of the sidelink;
wherein the first sidelink transmission is a transmission of a second stage sidelink control information,
when said computer program is run by a computer.
